(19) United States
(12) Patent Application Publication
(10) Pub. No.: US 2022/0255797 A1
(43) Pub. Date: Aug. 11, 2022

(54) METHODS, APPARATUS, AND SYSTEMS FOR DYNAMICALLY ASSEMBLING TRANSIENT DEVICES VIA MICRO SERVICES FOR OPTIMIZED HUMAN-CENTRIC EXPERIENCES

(71) Applicant: IDAC Holdings, Inc., Wilmington, DE (US)

(72) Inventors: Magurawalage Chathura Madhusanka Sarathchandra, London (GB); Dirk Trossen, London (GB)

(21) Appl. No.: 17/628,502

(22) PCT Filed: Jul. 23, 2020
(86) PCT No.: PCT/US2020/043300

§ 371 Date: Jan. 19, 2022

Related U.S. Application Data
(60) Provisional application No. 62/877,426, filed on Jul. 23, 2019.

(51) Int. Cl. H04L 41/0806

(52) U.S. Cl. CPC H04L 41/0806

(57) ABSTRACT

Methods, apparatus, systems, architectures and interfaces for a Device Packaging Entity (DPE) for dynamically packaging a set of resources for a transient device (TD) providing a user experience (UX). A method may include any of: determining services, devices, and resources, constituting the TD according to UX requirements associated with the UX or a Dynamic Programming model (DPM) of the UX; receiving configuration information associated with: (1) resources, and (2) devices associated with resources, available for services associated with providing the UX; selecting the set of resources for the TD according to: (1) required services or resources, associated with providing the UX, and (2) the configuration information, and (3) a set of resources satisfying requirements associated with the UX and the DP model; transmitting an instantiation message for configuring the selected set of resources for the TD; and transmitting and receiving information associated with the selected set of resources.

### BACKGROUND

The present invention relates to the field of computing and communications and, more particularly, to methods, apparatus, systems, architectures and interfaces for computing and communications in an advanced or next generation wireless communication system, including communications carried out using a new radio (NR) and/or NR access technology and communication systems.

Advancements beyond desktop computing have brought about new concepts for computing. Such new concepts include ubiquitous computing, which may also be referred to as distributed computing, and which provides immersive experiences for end users, for example, by supporting continuous computing on networked devices that are distributed at all scales and that are disposed at any location at any time. In a ubiquitous computing environment, computing tasks may be executed (e.g., realized, instantiated, conceived, generated, provided, etc.) to do any of collaboratively process information, migrate their place of execution, and spontaneously offload tasks to other devices; for example, based on changes in contextual information relevant to the experience. Performing computing tasks in such a manner may provide a desired immersive experience for an end user or a community/group of users.

In a computing environment having inexpensive and/or powerful devices (e.g., smartphones, Internet-of-Things enabled light bulbs, networked/wireless displays and/or user input devices and/or sensors, etc.), a proliferation of such devices (e.g., ubiquitous devices) creates a perception of ‘ubiquitous availability’ of (e.g., necessary) computing capabilities. A focus of many (e.g., prevalent) distributed computing paradigms that realize (e.g., execute, instantiate, provide, etc.) ubiquitous devices is optimization of device-specific experiences. This focus on device-specific experiences results in (e.g., end user, community, etc.) experiences, for example, that are stove-piped into device-centric experiences that are realized by highly optimized individual devices. Such distributed computing paradigms that focus on device-specific experiences do not provide immersive experiences for end users that may be achieved with a collaborative vision of ubiquitous computing.

### BRIEF DESCRIPTION OF THE DRAWINGS

Furthermore, like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a diagram illustrating layers of a computing system according to embodiments;

FIG. 3 is a diagram illustrating an experience realized through a set of chained named service function (SF)s and/or micro-services according to embodiments;

FIG. 4 is a diagram illustrating an experience realized at various layers, according to embodiments;

FIG. 5 is a diagram illustrating named service functions (SFs) executing at various layers, while nSFFs realize the SFs interconnectivity, according to embodiments;

FIG. 6 is a diagram illustrating a Device Packaging Entity (DPE), according to embodiments;

FIG. 7 is a diagram illustrating dynamic assembly of Service Functions (SFs), according to embodiments; and

FIG. 8 is a diagram illustrating a Service Function Chain (SFC) with a User Control SF (UCSF) as SF_{CONTROL}, according to embodiments.

### EXAMPLE NETWORKS FOR IMPLEMENTATION OF THE EMBODIMENTS

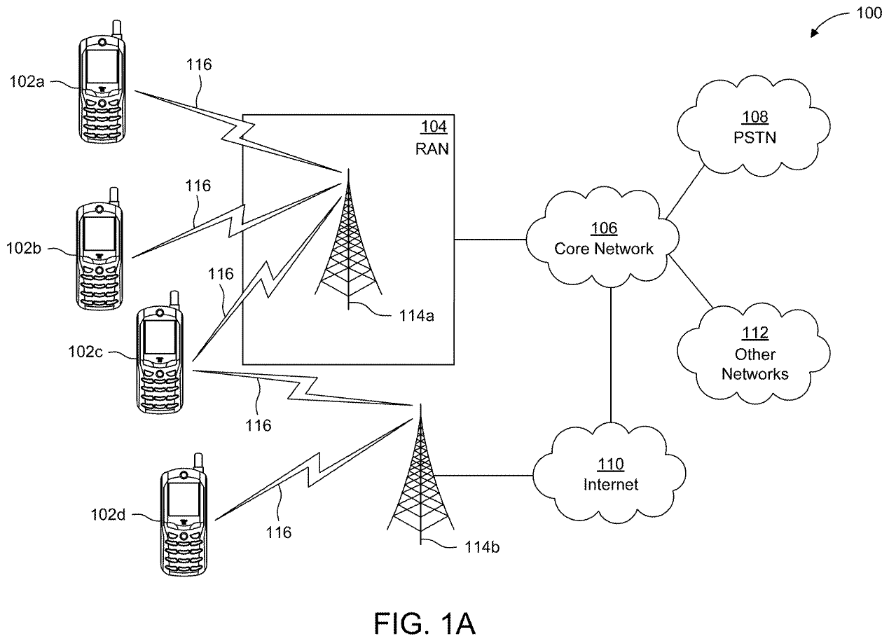

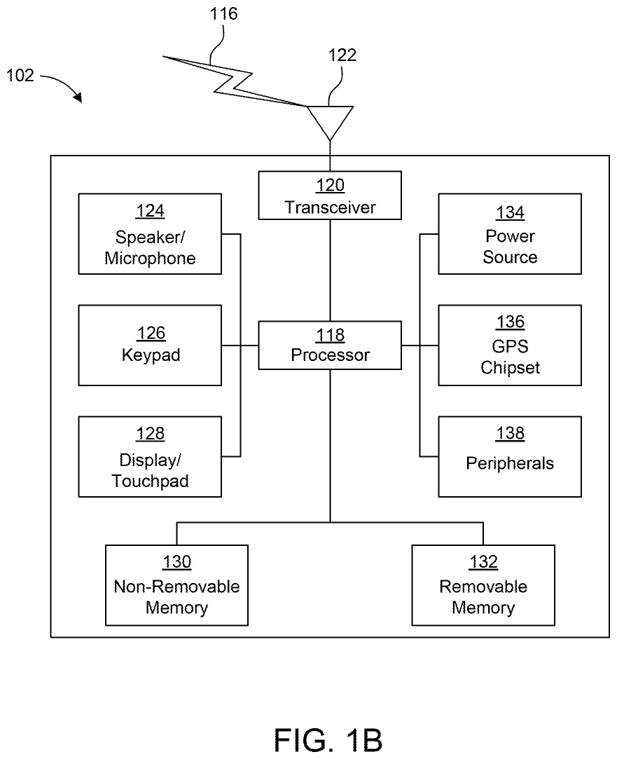

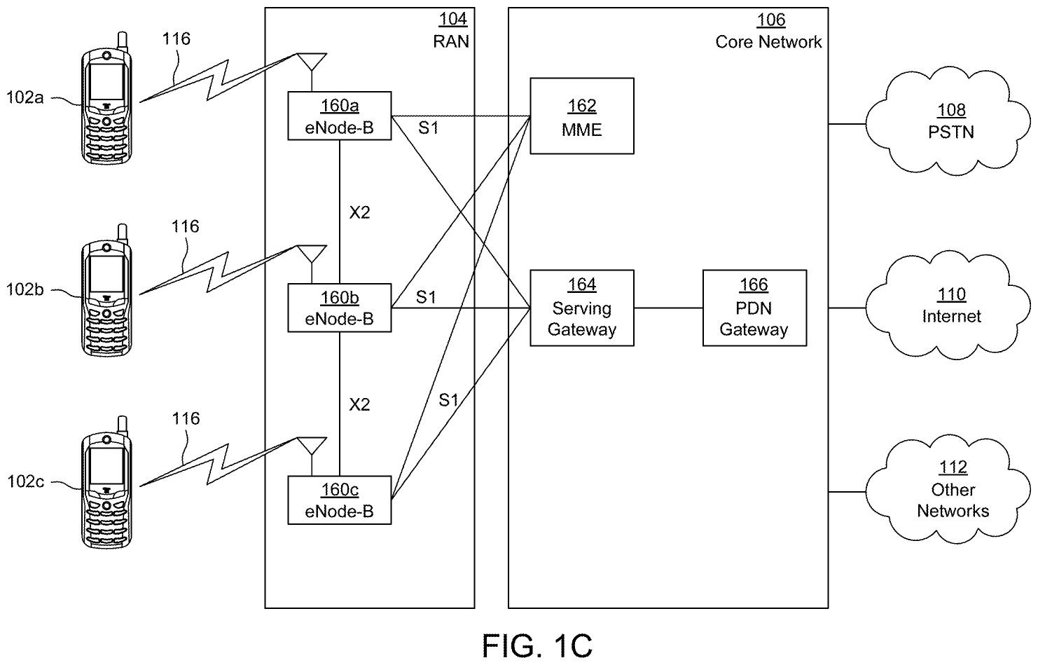

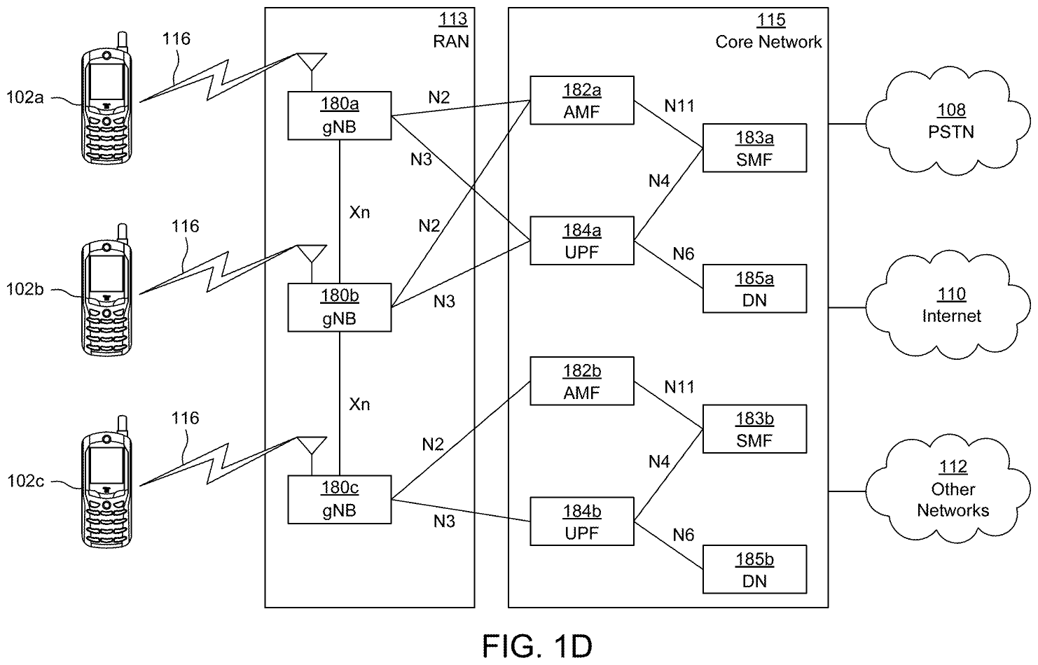

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### DETAILED DESCRIPTION

According to embodiments, a human-centric experience (e.g., as compared to a device-centric experience) may be provided (e.g., enabled) by devices and/or systems that (e.g., are designed and/or engineered to) provide an (e.g., user, end-user, community, etc.) experience-oriented approach to distributed and/or ubiquitous computing. According to embodiments, devices and/or systems providing human-centric experience may have requirements and/or constraints of (e.g., associated with) an (e.g., user, end-user, community, etc.) experience itself. In such a case, devices and/or systems providing human-centric experience may be optimized for (e.g., directed to, focused on, etc.) satisfying (e.g., meeting, achieving, exceeding, etc.) the requirements and constraints of the experience itself, while surrounding devices may provide (e.g., may be the realization of achieving) the immersive experience using a collaborative approach, for example, to achieve the human-centric immersive experience.

In a stove-piped, device-centric and/or device-specific experience environment, a device(s) and/or (e.g., an interconnectivity of) a system being used for such experiences are often fixed, that is, static and/or not dynamic. And such devices and/or systems are used as constraints to realize a given (e.g., device-centric and/or device-specific) experience. In such a case, a device's limitations may be (e.g., forced as) constraints on a user experience itself. In a case of an experience, for example, when a user desires to watch a movie in 4 k with English subtitles (e.g., the experience) on a mobile device, a device-centric realization of such an experience is limited by a device's screen size and a (e.g., video) resolution remains limited, for example, due to a limits in cellular network bandwidth and/or device computing capability. This can result in sub-optimal (e.g., user) experiences because of lower (e.g., 1080p) resolution on a small screen.

According to embodiments, in a human-centric realization of an experience (e.g., the viewing of a movie in 4 k with English subtitles), a specification (e.g., requirements, capabilities, thresholds, constraints, etc.) of a desired human-centric immersive experience may remain fixed, for example, for a desired duration. According to embodiments, a specification of a desired human-centric immersive experience may remain fixed, for example, while any of (e.g., underlying) computing objects, entities, their realizations, and their interconnectivity may be altered, for example, for maintaining and/or improving the experience (e.g., throughout its duration). In other words, according to embodiments, (e.g., the notion of) a human-centric immersive experience may be a (e.g., defining) aspect of assembling resources (e.g., from constituting devices) at runtime, while (e.g., the notion of) a device may be considered and/or referred to as a transient device. According to embodiments, in the case of a human-centric immersive experience realized with transient devices, this transient nature may allow for assembly of resources to be focused on delivering an optimal experience to the end user.

According to embodiments, for example, as described herein below, there may be methods, devices, entities, and/or systems for realizing (e.g., transient) devices for a human-centric immersive experience. According to embodiments, (e.g., transient) devices may be realized through an experience-focused approach, for example, to specify the (e.g., transient) device's micro-services. According to embodiments, a (e.g., transient) device's micro-services may be specified to provide (e.g., realize) a (e.g., specific, end-user, community, etc.) experience (e.g., desired by the user, at hand, etc.) through a runtime assembly of (e.g., required) resources realizing the (e.g., transient) device's micro-services.

According to embodiments, (e.g., specific, end-user, human-centric, community, etc.) experiences may be specified (e.g., defined, configured, instantiated, realized, etc.) as a dynamic programming (DP) model, for example, that may be associated with name-based micro-service function chains (MSFCs). According to embodiments, name-based MSFCs may be hosted (e.g., realized on, instantiated via, etc.) by a dynamically assembled set of resources, and the set of resources may be provided by distributed devices. According embodiments, a system may (e.g., dynamically) assemble a set of resources for realizing (e.g., specific, end-user, human-centric, community, etc.) experiences, for example, the set of resources (e.g., used) being associated with any number of distributed devices for hosting (e.g., realizing, instantiating, etc.) name-based MSFCs. According to embodiments, the dynamic assembly (e.g., by a system providing a human-centric immersive experience) of a set of resources may be driven by (e.g., performed according to) the provisioning of (e.g., suitable, human-centric, etc.) context information, for example, at runtime, and the continuous matching (e.g., based on such human-centric context information) against constraints within the DP model.

According to embodiments, a device packaging entity (DPE) may establish name-based relations (e.g., relationships, associations, mappings, MSFCs, etc.) associated with (e.g., suitable for) the exchange of information for executing a (e.g., suitable) MSFC that realizes a DP model, for example, associated with a defined (e.g., specified, configured, desired, etc.) human-centric immersive experience. According to embodiments, a DPE may collect information from devices. For example, the DPE may collect (e.g., suitable) context information from (e.g., distributed) devices that may be associated with (e.g., participate in) a system providing (e.g., dynamically assembling a set of resources for) an experience. According to embodiments, a DPE may match (e.g., compare, analyze, weigh, etc.) information against constraints. For example, a DPE may match context information against constraints associated with (e.g., configured in, set out in, specified in, etc.) a DP based specification (e.g., a DP model) of a (e.g., given, human-centric, end-user, community, etc.) experience. According to embodiments, a DPE may select a set of resources (e.g., optimally) matching constraints associated with (e.g., within) a DP model. According to embodiments, a DPE may and instruct (e.g., realize, instantiate, command, trigger, etc.) a set of (e.g., selected) resources, for example, to establish name-based relations (e.g., MSFCs) suitable for the exchange of information for executing a suitable MSFC that realizes a DP model associated with a specified human-centric immersive experience.

According to embodiments, transient devices may be established, for example, by a DPE, in order to provide a human-centric immersive experience. According to embodiments, a transient device may be specified according to micro-service (e.g., MSFC) based experiences associated with a DP model (e.g., for the human-centric immersive experience). According to embodiments, transient devices may be established according to context information, for example, context information collected from available resources in a networked environment. According to embodiments context information (e.g., associated with available device and/or network resources) may be matched (e.g., compared) against information (e.g., constraints) associated with a DP model for the experience. According to embodiments, a set of resources for (e.g., that optimize) a DP model may be chosen according to matching of the context information and the constraints. According to embodiments, the (e.g., optimized) set of resources may be instructed (e.g., signaled, commanded, associated, mapped, configured, etc.) to form (e.g., instantiate, execute, perform, realize, etc.) a MSFC (e.g., a suitable micro-service name-based function chain), for example, to execute the MSFC for the implementation of the DP model for (e.g., defining) a human-centric immersive user experience.

According to embodiments, in a human-centric realization of an experience, devices associated with providing the experience may be dynamically selected and/or migrated. For example, in the case of an experience provided according to a DP model of a user viewing of a movie in 4 k with English subtitles, as a user enters his living room, the display(ing) of the movie may be migrated to a nearby UHD TV screen. That is, according to embodiments, the display may be migrated, for example, while network connectivity is switched to a home WiFi system and the subtitle task of the video application (e.g., a MSFC associated with subtitling) is migrated to a home computer. In such a case, the originally used mobile device may be relieved from (e.g., performing, providing, etc.) almost any task, for example, except for some tasks such as a control element associated with user input (e.g., user intervention).

According to embodiments, a human-centric realization of an experience (e.g., a DP model of such experience) may be characterized by (e.g., associated with) dynamics (e.g., high dynamics, rapid change, transient requirements, etc.) for any of contributing computing objects (e.g., entities, MSFCs, transient devices, etc.) and interconnectivity (e.g., being used) between them. According to embodiments, such (e.g., high) dynamics may be associated with (e.g., driven by, characterized by, specified according to, etc.) any of: (i) a specification of an (e.g., human-centric immersive, desired, etc.) experience; (ii) characteristics of (e.g., contributing) objects (e.g., entities, devices, etc.) and their connectivity; and (iii) contextual information (e.g., information on any of location, bandwidth, hardware capabilities, etc.) associated with the (e.g., desired) experience.

According to embodiments, a specification of an experience may be a programming framework, for example, that may lift from (e.g., that may interact with, associate with, executing processes (e.g., of displaying, processing and receiving a video through locator-based endpoint models) in order to generate (e.g., associate, map, etc.) named relations of service endpoints (e.g., MSFCs). According to embodiments, the named relations (e.g., for MFSCs) may be determined at runtime, for example, based on changes imposed through contextual changes in a (e.g., overall) system.

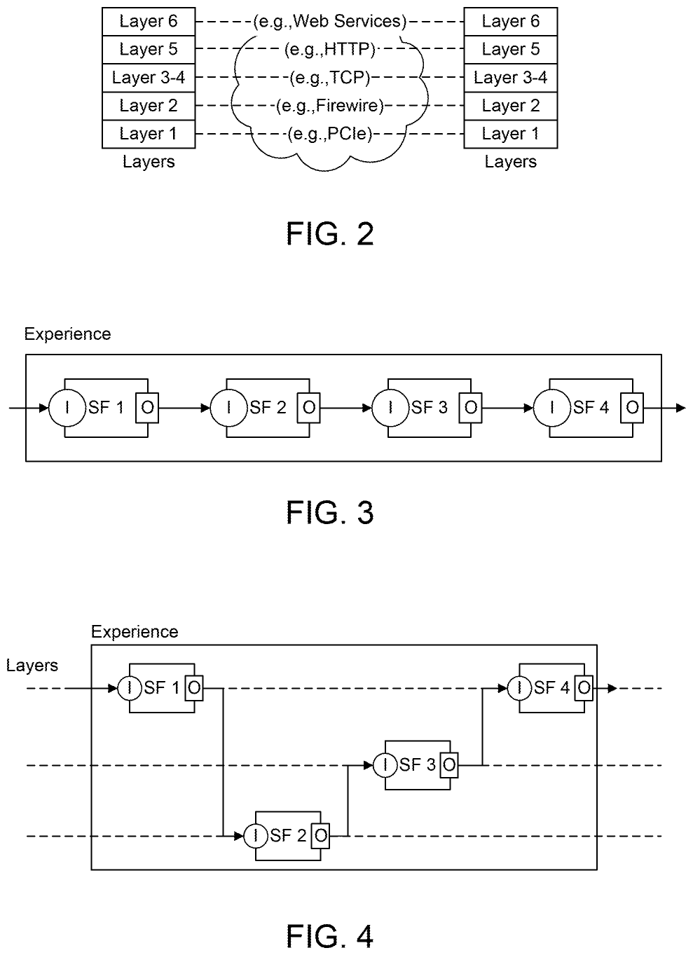

FIG. 2 is a diagram illustrating layers of a computing system according to embodiments.

According to embodiments, key to characteristics of contributing objects and their connectivity is that such may exist at many layers of a (e.g., overall) system, for example, as shown in FIG. 2. According to embodiments, dynamic changes may be made throughout (e.g., all and/or any of) the layers of the system, and, for example, such dynamic changes may not be restricted to (e.g., only) one layer. For example, in the case of the user viewing the movie in 4 k with English subtitles, according to embodiments, the internal intra-device connectivity to any of the display screen, and the subtitle task, for displaying the video within a single mobile device may be swapped, for example, with a UDP network connectivity to the nearby TV screen (e.g., for pure video streaming), and a TCP connectivity to a nearby 3 PC, respectively.

According to embodiments, such dynamic changes to contributing objects, and, for example, the optimization of a system associated with the contributing objects, may be (e.g., primarily) driven by optimizing an experience, such as, for example, any of a human-centric immersive end-user experience, a community experience, etc. That is, according to embodiments, the experience (e.g., of the end-user) drives the performance (e.g., of the system) with the components contributing to the optimization of the system, for example, instead of optimization of the (e.g., the performance, use, allocation, etc., of) individual components contributing to the experience.

According to embodiments, context information, which may interchangeably be referred to as contextual information, associated with the (e.g., desired) experience may be used to optimize performance of the experience (e.g., by the system). For example, according to embodiments, context information may include any of location, user, congestion, resource, environment, etc., information, for example, that may be used for determining (e.g., the right) devices at (e.g., the right) layers at (e.g., the right) times to be used, for example, at any (e.g., determined) moment in time. According to embodiments, context changes may take place momentarily (e.g., occur for small amounts of time), for example, requiring a (e.g., possible) reconfiguration of any part of or the entire system.

### Framework for Specifying an Experience

According to embodiments, a (e.g., human-centric) specification of, and/or a framework for specifying, an experience may be an (e.g., fundamental) aspect of a system providing (e.g., optimizing) human-centric immersive end-user experiences, that is, for example, systems (e.g., engineered) for and/or optimized to (e.g., end-user, human-centric, etc.) experiences themselves. According to embodiments, a human-centric specification (e.g., what determines a specific experience for a system providing a human-centric immersive experience) may be an (e.g., end) goal for what is to be achieved by a system. That is, for example, human-centric experiences (and/or specifications thereof) may focus on a users' end goal, leaving the objects (e.g., devices, entities) to achieve (e.g., deliver, present, execute, instantiate, etc.) the experience to be resolved by the system, for example, at a specific instant of time when the experience is being provided.

According to embodiments, for a human-centric specification, for example, associated with a system providing a human-centric experience, a users' goal may be (e.g., considered as) the problem at hand. In a case where an end-user's desired goal (e.g., for the experience) is considered the problem at hand, a system may provide procedures (e.g., problem-specific solutions, MSFCs, commands, inquiries, etc.) for (e.g., towards) achieving the desired goal. That is, according to embodiments, a system may provide problem-specific solutions for solving the problem at hand, that being (e.g., providing) an end-user's desired goal for an experience. According to embodiments, a system may provide an optimal set of resources, for example, for executing problem-specific solutions.

According to embodiments, (e.g., human-centric immersive, end-user, community, etc.) experiences and/or any of an associated specification or specification framework may (e.g., often) consist of any number of sub-elements (e.g., sub-experiences, sub-aspects, sub-functions, sub-routines, sub-specifications, sub-contexts, etc.). According to embodiments, such sub-elements, may be put together (e.g., realized, instantiated, executed, assembled, defined, configured, etc.) for constructing any of audio, visual, hepatic, etc., elements of an (e.g., human-centric, interactive, immersive, end-user, etc.) experience. For a system providing (e.g., discovering, determining, selecting, etc.) an optimal set of resources, experiences that are highly human-centric may be (e.g., may become) increasingly complex to specify, for example, due to their complex requirements (and constraints) and their dynamic nature.

According to embodiments, any of detailing, specifying, and/or separating (e.g., rather abstract, human-centric, end-user, immersive, etc.) experiences into (e.g., much more manageable) sub-elements may be done by any of defining and (e.g., then) identifying sub-elements in a (e.g., larger, user) experience, for example, for a specification framework to be used in human-centric systems. According to embodiments, similar to detailing, specifying, and/or separating experiences into sub-elements, a problem (e.g., at hand) of providing a user's goal for an experience may be broken down into sub-problems that may be solved independently, for example, towards solving the larger problem, for example, as described by a divide-and-conquer principle.

According to embodiments, sub-problems may be divided according to any of requirements (e.g., associated with any of an end goal of a user, an identified problem at hand, a desired experience, etc.) and constraints (e.g., characteristics of any of the user and the environment, context information, associated with the problem at hand and/or the requirements, etc.). According to embodiments, requirements associated with (e.g., of, for, based on, etc.) an experience may include any of desired features and (e.g., acceptable) levels (e.g., thresholds, indicators, types, etc.) of violations, for example, per execution of the experience.

In a case of device-centric (e.g., traditional and/or conventional) systems and/or experiences, for example, solutions do not consider dynamic execution of functions and change of contexts and/or assume a static set of execution points and contexts, and further, (e.g., attempt to) provide solutions. In such a case, the solution is an attempt (e.g., in the form of pre-packaged monolithic software and/or hardware operations) that fits all (e.g., of the static set), leading to suboptimal experiences. Furthermore, in the case of device-centric systems, changes in contextual information may exceed the acceptable levels of violations of requirements in the system, leading to a poorer experience. According to embodiments, in human-centric (e.g., in contrast to device-centric) systems, a quality of adaptability to contextual changes (e.g., dynamic assembly) may determine (e.g., drive) division of sub-problems, for example, for runtime optimization of human-centric experiences.

According to embodiments, unknown parameters and/or states (e.g., unknown parameters and/or unknown state changes) of the system and/or the environment, may be discovered by a system providing a human-centric (e.g., immersive) experience, and, for example, may be used for optimizing the experience. According to embodiments, there may be a set of known parameters that are, for example, associated with a problem at hand and/or a system, and that are generated at (e.g., during) an occurrence of a runtime optimization of a human-centric experience. In the case of providing a human-centric (e.g., immersive) experience, changes in contexts may result in changes in any of parameters and states, for example, which may not yet be discovered (e.g., not known) by the system, and may (e.g., therefore) be referred to as unknown parameters and/or states (e.g., changes) of the system and/or the environment. According to embodiment, once such unknown parameters and/or states are known to the system providing the experience, they may be used for (e.g., further) optimizing the experience. According to embodiments, procedures (e.g., operations, routines, services, resources, etc.) for providing a (e.g., human-centric) experience may be categorized into any of at least two categories: 1) design-time operations, for example, that may perform divide-and-concur operations/methods based on the (e.g., identified) known; and 2) run-time operations, for example, that may continuously discover the unknown and may adapt towards an optimal experience.

According to embodiments, a dividing of a (e.g., human-centric immersive) experience into any of sub-elements and sub-problems may vary according to a (e.g., selected) strategy for such dividing of the experience. That is, the task of dividing an experience into sub-elements may be performed according to (e.g., based on) a chosen dividing strategy. According to embodiments, a strategy for dividing an experience may be (e.g., done, driven, etc.) according to (e.g., based on, driven by, etc.) any of: (1) characteristics of the experience (e.g., a user wants to emphasize a viewing experience, hence a characteristic of a D/display function); (2) characteristics of a system (e.g., providing the experience, hence a characteristic of having better compute resources, for example, in certain places, in an environment); and (3) constraints, which may be defined, for example, as crucial (e.g., hence a characteristic of battery life, for example, when considering mobile initiated experiences.

According to embodiments, an experience may be divided into sub-elements that may be a set of micro-services (e.g., a MSFC). For example, according to embodiments, design-time dividing procedures may be carried out according to (e.g., based on) a dividing strategy, and, for example, the outcome of such procedures may result in sub-elements in the larger experience as a set of micro-services. For example, in a case of a simple remote video viewing experience, the set of micro-services may be any of a D function for the viewing, a P function for the processing, an R function for networking, etc. According to embodiments, such design time outcome (e.g., the set of micro-services) may (e.g., then) be an input (e.g., used by the system) for maximizing the experience at runtime.

According to embodiments, any of a micro-service and/or a set of micro-services may be modeled, for example, as a directed graph. That is, according to embodiments, any of micro-services, their inter relationships, and communications (e.g., that are constructed as a result of divide-and-concur procedures) may be modeled as a directed graph, for example, for optimizing its execution path. According to embodiments, for example, according to (e.g., based on, using, etc.) a model of micro-services, solving a users' initial problem (e.g., an end-goal, a desired experience, etc.) may (e.g., construed as, considered to be, associated with, then be seen as, etc.) performing divide and concur at design time for identifying such micro-services, for example, while finding (e.g., optimal) executions of resulting micro-services by minimizing the violations of requirements.

According to embodiments, a service function chain (SFC), which may be a micro-service function chain (MSFC), may be associated with (e.g., specify, instantiate, realize, etc.) a set of micro-services, for example, as an outcome of a design process, and a SFC may be (e.g., provide) a framework to represent micro-services, for example, along a Service Function Path (SFP) along a set of (e.g., well-defined) Service Functions (SFs). According to embodiments, a (e.g., each, any) SF may be associated with (e.g., based on, well-defined) input/output (I/O) interfaces, for example, to expose software and/or hardware operations, such as, for example, a problem-specific solution to a micro-service identified in the design-time divide-and-conquer process.

FIG. 3 is a diagram illustrating an experience realized through a set of chained named service functions (SFs) and/or micro-services, according to embodiments.

According to embodiments, a SFC concept may be applied to (e.g., associated with, extended to, adapted for, etc.) name-based relations, for example, in the case of a name-based service function forwarder (nSFF) component within a SFC framework. For example, the SFC concept may be extended onto name-based relations, for example, as they may be used for micro-services utilizing certain information, e.g., URLs such as foo.com, as identifiers. Such SFC concept applied to name-based relations is shown in FIG. 3. According to embodiments, a realization of a (e.g., human-centric, immersive) experience may be (e.g., represented as, considered to be, etc.) an SFC, while the SFs (e.g., included in the SFC) may be the constituents making up the realization of the ‘divide-and-conquer’ problem solving (e.g., may be micro-services associated with sub-problems). According to embodiments, a realization of (e.g., such) SFs may be at any layer of (e.g., the involved) resources of the wider system.

According to embodiments, a run-time problem of choosing a (e.g., best possible) set of micro-services, for example, for minimizing the total (e.g., number of, requirement of, threshold of, etc.) violations of the experience, may be formalized (e.g., considered as, reduced to, etc.) as a multistage dynamic programming decision process. According to embodiments, such multistage dynamic programming decision process may construct a solution (e.g., the experience) to the problem, for example, based on solutions of its sub-problems (e.g., micro-services).

According to embodiments, selection of a suitable micro-service may be carried out (e.g., performed, decided, configured, etc.) at any (e.g., each) stage of a decision-making process. According to embodiments, a cost of selecting a micro-service at stage i may be as shown in Equation (1):

fᵢ(dᵢ,sᵢ), Equation (1),

where dᵢ is a permissible micro-service that may be chosen from the set of all possible micro-services Dᵢ, and sᵢ is the requirement violations of the experience at stage i. According to embodiments, a set of possible micro-services, Dᵢ, available at a given stage may depend upon the requirement violations of the process at that stage, sᵢ, which may be formally written as Dᵢ(sᵢ); however, for simplicity, the requirement violations of the process at a stage may be denoted as Dᵢ.

According to embodiments, solving a problem of choosing the optimal execution of micro-services dᵢ, dᵢ₋₁, . . . , d₀, may be to solve the following problems, as shown in Equation (2):

v=Min{fᵢ(dᵢ,sᵢ)+fᵢ₋₁(dᵢ₋₁,sᵢ₋₁)+ . . . +f₀(d₀,s₀)}, Equation (2),

subject to Equations (3) and (4):

dᵢ∈D, Equation (3),

v≤V, Equation (4),

where Vⱼ is the total requirement violations allowed for the experience j, and v is the minimum requirement violation value achieved with optimal micro-services chosen. According to embodiments, solving the (e.g., above) dynamic programming problem may result in a set of optimal micro-services, for example, that once collectively executed provides an optimal experience. According to embodiments, with respect to the below description of contextual assembly of an experience, run-time procedures may be for discovery (e.g., e.g., of new devices and/or states devices due to contextual changes) and optimizing the experience according to the unknown, for example, by solving the above problem for choosing dᵢ, dᵢ₋₁, . . . , d₀, and executing (e.g., the chosen) micro-services.

### Constituting/Instantiating Micro-Services at Any Layer

Layering, for example, in any of computing, networking, communication, digital, etc., systems, may be used, for example, for isolating concerns in various parts of systems. In a conventional system, e.g., traditional computing and/or networking system, layers are (e.g., universally) agreed conventions (e.g., kernel vs user space components in OS) or standards for methods and/or procedures (e.g., network OSI layering) within systems. Furthermore, components instantiated within such layers provide services and/or functions to a layer immediately above their layer, and components maintain such layering, for example, until there is a change in any of conventions or standards. A layer may be any of a network layer, a physical layer, an application layer, a data layer, a link layer, a transport layer, a session layer, etc.

According to embodiments, for example, in a case of the user viewing the 4 k movie with English subtitles, a function, the D function, may read frames, for example, from a framebuffer in a local device memory, when executing on the mobile device. In such a case, however, when the D function is chosen to be executed at a nearby TV (e.g., when a high-resolution TV becomes available, or another similar change in context occurs), a next frame may be delivered to the D function over the network. According to embodiments, in such a case, if the frames are delivered to the D function over the HTTP protocol, the instance of the D function may execute at a higher layer in the system, than, for example, a layer in the system for when the D function reads from the local framebuffer.

FIG. 4 is a diagram illustrating an experience realized at various layers, according to embodiments.

According to embodiments, for example referring to FIG. 4, a (e.g., suitable) layer may (e.g., should) be dynamically chosen per any (e.g., each, all, some, few, etc.) SF, for example, when optimizing experiences at runtime. According to embodiments, such dynamically chosen layers may be considered as a second degree of freedom, for example, for a system providing a human-centric immersive experience. According to embodiments, for example, as discussed above with respect to a specification framework, a realization of a set of micro services may be represented as a chain and a realization of a micro service may be represented as a SF. According to embodiments, for realizing inter-connectivity of SFs within an SFC, the interfaces of SFs may be assigned with a name (e.g., named endpoints), and the SF may be chained as a directed graph relationship of the named endpoints. According to embodiments, once chained, intercommunications between two SFs may be realized by a nSFF, which route and/or forward information from a SF to another (e.g., next) SF in a chain.

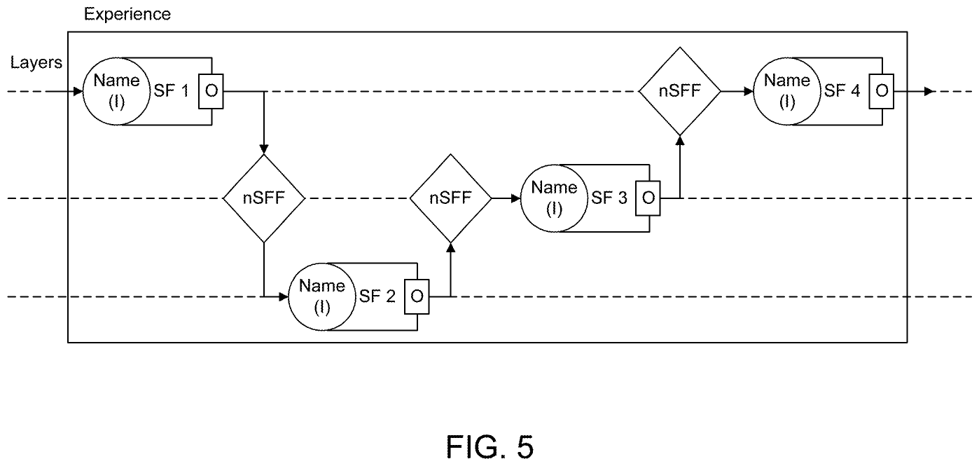

FIG. 5 is a diagram illustrating named service functions (SFs) executing at various layers, while nSFFs realize the SFs interconnectivity, according to embodiments.

According to embodiments, while an executing layer of a (e.g., particular) SF may be chosen at runtime, cross-layer inter-SF communication between named-SFs may be realized by nSFFs, for example, as shown in FIG. 4. According to embodiments, a realization of a nSFF may occur (e.g., be instantiated, be realized, be executed, etc.) at the HTTP level. According to embodiments, in addition to selecting (e.g., optimal) SFs, selecting an (e.g., optimal) executing layer for a (e.g., any, each, all, etc.) SF (e.g., and their intercommunications) may be done at runtime, for example, when solving a minimization (e.g., of requirement violations) problem, as described above.

### Contextual Assembly of an Experience

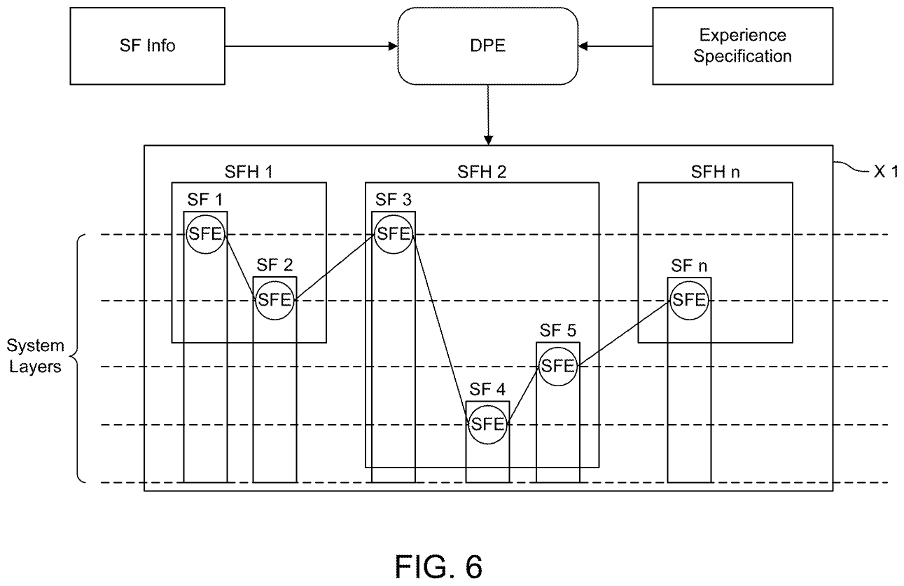

FIG. 6 is a diagram illustrating a Device Packaging Entity (DPE), according to embodiments.

According to embodiments, in a case of a device experience, for example, as discussed above, such device experience may be a dynamically determined set of Service Functions (SFs) dynamically interconnected, for example, to satisfy time-varying specifications (e.g., requirements and/or constraints). According to embodiments, a (e.g., specific) contributing resource component may realize an SF, while a (e.g., specific) packaging of a set of SFs may define a human-centric experience. According to embodiments, a Device Packaging Entity (DPE) may dynamically assemble SFs, for example, in a contextually relevant manner, to represent a human-centric experience. According to embodiments, a DPE, for example, in the manner described above, may realize (e.g., instantiate, execute, etc.) a human experience as a transient device, for example, by dynamically assembling and/or packaging (e.g., the most suitable) SFs.

In a case of stove-piped, mobile device centric, experiences, devices are not transient. However, in such a case, other devices are (e.g., usually) used, such as, for example, cloud-based servers providing remote compute resources for any of mapping, video or other services to applications running on end user devices. According to embodiments, a transient device may be a combination of any of resources and devices, for example, a combination of a remote compute resource and an end user device. According to embodiments, in a human-centric experience notion, end users may be (e.g., entirely) freed from (e.g., a notion of) needing to utilize (e.g., a singular, a plurality of, etc.) end user devices, such as smartphones. According to embodiments, in a human-centric experience notion, end users may be provided transient devices, for example, that may be (e.g., purely) defined by an instantaneous execution of any number of experiences desired by the end user.

According to embodiments, a DPE may be a logical decision-making entity which takes (e.g., inputs, receives, determines, etc.) characteristics of any of: (i) SFs, (ii) SFHs (e.g., entities in the system hosting SFs), and (iii) an experience definition (e.g., a specification, in the form of the DP model) when packaging a dynamic notion of a transient device. According to embodiments, a Service Function Endpoint (SFE) may realise communication procedures of SFs. According to embodiments, for example, as shown in FIG. 6, SFs may be created to include any (e.g., some, each, all, a subset of, etc.) layers, for example, based on requirements and/or constraints.

According to embodiments, a DPE may be executed in any number of locations, for example, within a distributed system. According to embodiments, a location may be (e.g., the equivalent of) an (e.g., existing) smartphone, for example, albeit purely focused on the assembly of the distributed execution of the experience, while (e.g., possibly) contributing resources to the execution of the experience. According to embodiments, a DPE may be a software module, for example, on a smartphone. According to embodiments, a DPE may be realized in a reduced device, for example, not providing compute resources itself but merely providing (e.g., serving the purpose of) assembling of transient devices. According to embodiments, such DPE may be for scenarios where execution of the user experience is (e.g., fully) distributed, and such DPE may not involve (e.g., include) any end user device, and may be considered as a reduced, purely DPE executing device. According to embodiments, (e.g., the only personalized aspect) such a DPE may provide dynamic assembly of user experiences through the DPE functionality executed locally on the device. Additionally, such device might realize human (e.g., end-user)-centric authentication services, for example, for resources being used for the experience.

### Procedures for Assembling a Transient Device at Various Layers

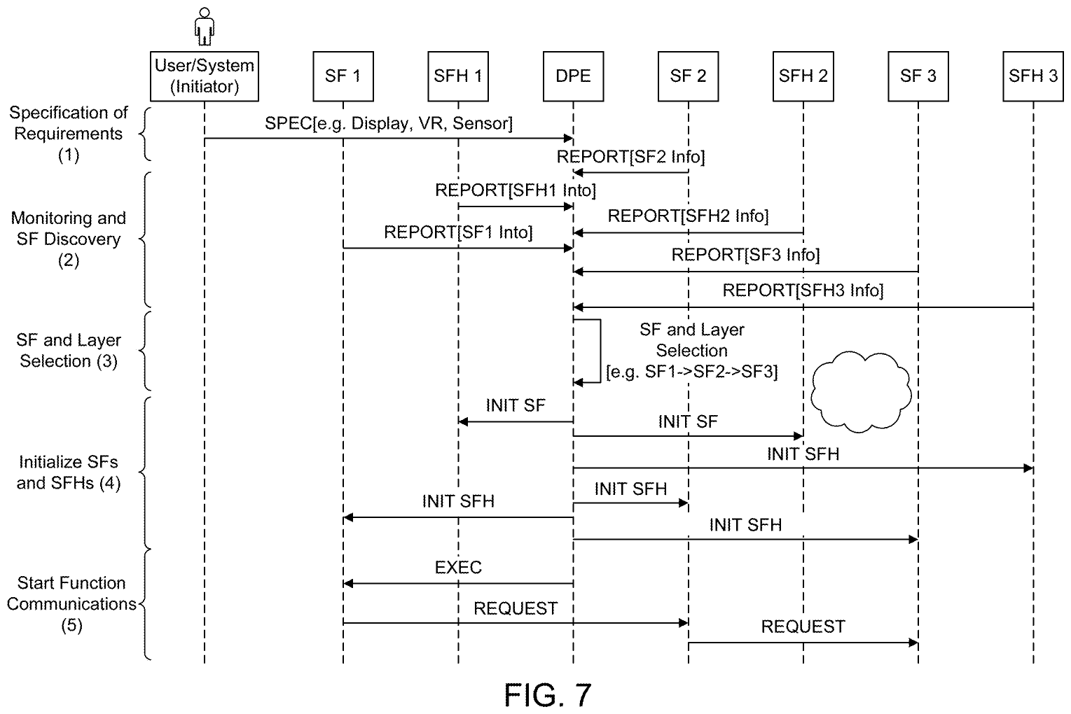

FIG. 7 is a diagram illustrating dynamic assembly of Service Functions (SFs), according to embodiments.

According to embodiments, a SF may be dynamically assembled according to any of packaging and chaining a device experience, for example, that is associated with a human-centric (e.g., immersive) experience. According to embodiments, a device experience may be any of packaged and chained according to any of: (1) a specification of a device experience, for example, provided to a DPE; (2) information associated with (e.g., derived from, about, determined according to, characterizing, etc.) SFs, for example, available (e.g., made available, provided, etc.) to a DPE; (3) a DPE selecting a (e.g., specific) set of SFs, for example, for constructing a device experience; (4) a DPE initializing and/or pinning SFs, for example, with SFHs, for a chain(ed) duration (e.g., a duration of a package(d) period, provided in the specification); and (5) starting (e.g., instantiating, executing, performing, etc.) SF communications, for example, for the chained duration.

According to embodiments, a specification of a device experience (e.g., the problem at hand, including Vⱼ as described above, etc.) may be provided to a DPE, for example, by any of a user (e.g., through a user interface, when starting a video viewing application for viewing the 4 k movie), and another entity in the system (e.g., one SF requesting another helper routine consisting of a chain of sub routines). According to embodiments, a specification of a device experience may include triggers, for example, specifying information associated with events. According to embodiments, such events may trigger any of an assembly process or any other operation associated with the device experience.

According to embodiments, triggers may be associated with (e.g., embody, be derived from, indicate, reflect, etc.) constraints of a (e.g., the afore described) dynamic programming problem. According to embodiments, the information, for example, included and/or indicated in a specification of a device experience (e.g., along with a trigger), may include an identifier for a transient device, which may be referred to as device ID and/or a transient device ID (TDID). It is notable that a Device ID and/or a TDID may be different from other identifiers, such as device-centric identifiers that associate each platform to a specific execution device, such as a smartphone, such as might be used, for example in Android platforms. According to embodiments, a Device ID (e.g., TDID) may denote a transient identifier, for example, that is tied to a (e.g., human-centric) experience (e.g., in contrast to a device-centric ID tied to specific execution points of the underlying micro services).

According to embodiments, for a specification of a device experience application requirements may be specified, for example, using existing specification languages, such as used for cloud topological and/or orchestration specifications (e.g., TOSCA used in EU-FLAME project). Android developers use Manifest files for specifying various information about applications. According to embodiments, for a specification of a device experience a manifest file may (e.g., also) be used, for example, for defining custom specification parameters. According to embodiments, for a specification of a device experience, device-local micro service installation may be combined with distributed micro service deployment, for example, through network orchestration, for example.

According to embodiments, a DPE may have and/or use information associated with SFs. According to embodiments, information of SFs may be made available, for example, by a DPE (e.g., continuously) monitoring (e.g., for) SFs, or in other words, discovering information associated with any of known and unknown SFs, which may include the set of all possible micro services Dᵢ as discussed above. According to embodiments, SFs and/or any associated information may be any of monitored and discovered for any of their availability and utilization (e.g., in a case where existing SF with required hardware decoding has enough CPU resources to serve a new chain). According to embodiments, SFs and/or any associated information may be any of monitored and discovered according to any of active discovery (e.g., a DPE requesting information from/about SFs of interest) or passive discovery (e.g., SFs reporting information to a known interface of DPE).

According to embodiments, a DPE may collect contextual information. According to embodiments, contextual information may be collected from any of (e.g., discovered, unknown) SFs and other information sources, such as radio network information, for example, that are relevant for the specified experiences, allowing for deriving (e.g., necessary) constraints, for example, as discussed above. According to embodiments, service discovery frameworks, for example, such as multicast DNS (mDNS) or repository based discovery schemes can be used to discover relevant SFs. According to embodiments, (e.g., existing, well-known) monitoring frameworks, such as Telegraf and FLAME CLMC, may be extended to monitor SF parameters, for example, at various layers.

According to embodiments, a DPE may select a (e.g., specific) set of SFs for constructing a device experience, for example, by taking information of (e.g., associated with) available SFs, and the specifications of the device experience solving the problem formulated, for example, according to matching constraints against demands. According to embodiments, for a DPE, a specification may be (e.g., taken as) a demand, for example, that may identify any of a set of SFs and their communication methods, for example, based on known SFs and SFHs in the system (constraints). For example, a specification may identify D, P and R functions, for a duration of a video viewing (e.g., experience), and may identify that the hardware decoder R SF's SFE supports a PCIe communication method, for example, based on system constraints.

According to embodiments, a DPE may initialize and pin SFs with SFHs, for example, for a duration of a packaged period (e.g., as provided in a specification). According to embodiments, as a part of an (e.g., this) initialization process, messages may be sent to (e.g., corresponding) entities, for example, for configuring their computing resources and setting network interfaces. According to embodiments, a set of SFs may be pinned to corresponding SFHs according to any of a Context ID and a Device ID provided in a specification.

According to embodiments, SF communications may be started, for example, for the chained duration. According to embodiments, (e.g., in order to start SF communications) a DPE may signal a readiness of a chain, for example, to a first SF (e.g., a EXEC message to SF1) of the chain. According to embodiments, such (e.g., explicit) signaling may allow for any of implementing correctness and atomic execution of an SFC, for example, by rolling back the reservation (e.g., initializing) and pinning of SFs on SFHs, for example, in a case of all successful SF initializations in case any SF initialization might have failed. According to embodiments, in such a case, any of monitoring for SFs, selecting a set of SFs, and reservation and pinning of SFs on SFHs may be executed (e.g., again) until a successful SFC (e.g., in its entirety) may be initialized. According to embodiments, explicit signaling may ensure that the execution will (e.g., only) start upon the availability of a (e.g., fully initialized) chain. According to embodiments, a SPEC (e.g., specification) message may trigger packaging of SFs, for example, as shown in FIG. 6.

### Contextual Assembly of Experiences at an Application Layer

According to embodiments, (e.g., monolithic) applications may be decomposed into SFs, for example, to be assembled (e.g., packaged) at runtime. In a (e.g., conventional) case, applications are (e.g., conventionally) packaged by application developers at design time. In such a (e.g., conventional) case, applications are (e.g., conventionally) packaged and/or distributed, for example, for installing as a single standalone application on devices, utilizing a central ‘playstore’ approach, where available applications are browsed and/or chosen. In such a (e.g., conventional) case (e.g., due to a static and/or inflexible nature of applications and/or their packaging), application user experiences become sub-optimal. According to embodiments, applications may be decomposed into SFs, for example, (e.g., monolithic) applications may be decomposed into SFs, and may be assembled at runtime, for example, in a manner adapting to varying contextual parameters, which may, for example, provide improved user experiences.

According to embodiments, transient device nature may be realized, for example, at the application layer. According to embodiments, a (e.g., any) device capable of running (e.g., executing, instantiating, realizing, hosting, etc.) application SFs may be (e.g., considered) an SFH (e.g., a mobile device, a cloud VM, etc.), for example, enabling a high degree of distribution of SFs. According to embodiments, packaging procedures may (e.g., then) take available SFs and SFH at runtime and package an application, for example, by dynamically chaining a chosen SF. According to embodiments, such packaging may include deployment information associated with (e.g., about, on, for, etc.) a host SFH where the packaging is executed, such as an available smartphone, as well as deployment information associated with (e.g., about, on, for, etc.) remote execution points, (e.g., SFHs). According to embodiments, deployment information may be (e.g., then) used for (e.g., the process of) selecting (e.g., optimal) execution points, for example, including those on the host SFH.

According to embodiments, methods of device-initiated service deployment through mobile application packaging may be used, for example, for any of: (1) deployment of application level resources on selected SFHs, for example, as a realization of specification of requirements (e.g., the specification); and (2) initializing SF procedures. According to embodiments, methods of pinning service function chains to context-specific service instances may be used, for example, for pinning (e.g., such) application-level SFs to specific SFHs in a deployed system. According to embodiments, resources associated with (e.g., for, belonging to, on, etc.) an initiating device, such as an existing smartphone, may be utilized as SFs, for example, by utilizing task offloading methods for possible remote execution of partial device application functionality based on dynamic offloading criteria. According to embodiments, task offloading may be done by, for example, converting local application functions into fully functional distributed SFs, which may be added to an overall selection process, for example, when selecting SFs and associated layers.

### Procedures for Assembling a Transient Device at Various Layers

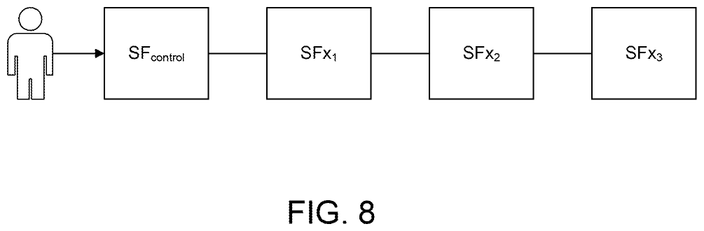

FIG. 8 is a diagram illustrating a Service Function Chain (SFC) with a User Control SF (UCSF) as SF_{CONTROL}, according to embodiments.

According to embodiments, codification may take requirements provided by a developer (e.g., who usually takes user requirements into account, such user requirements either known or being provided by end users) and may determine a type of SFs and their ordering to be used, for example, for meeting functional requirements of an, experience, as shown in FIG. 8.

According to embodiments, a User Control Interface may be (e.g., assumed to be) a first SF, for example, interfacing (e.g., directly) with a user for providing control of a device, for example, which may be a SF accepting an instruction to “EXEC” (e.g., execute) a (e.g., SF) chain, as shown in FIG. 7. According to embodiments, requirement-to-SF-type mapping may be done, for example, using a set of pre-set mapping rules that may be made available in advance (e.g., mapping functional requirements provided by the user to SFs). According to embodiments, (e.g., these) mapping rules may represent a codification of a distributed experience, for example, in the form of requirements that need to be met. According to embodiments, mapping rules (e.g., as described below) may be a dynamic programming model embodiment, for example, allowing for continuously matching the monitored constraints of the system against the requirements expressed in the mapping rules. According to embodiments, through (e.g., this) continuous matching, a (e.g., optimal, best matching, etc.) set of service functions may be (e.g., is being continuously) selected.

There may be a case of a simple video viewing experience with no extra processing requirement. According to embodiments, such a case, such a case may (e.g., only) result in ‘Display’ and ‘Receive’ SFs, for example, having a mapping of Control->Display->Receive. According to embodiments, in such a case, a requirement specification with an added frame processing functional requirement may result in ‘Control’->‘Display’->‘Process’->‘Receive’ mapping. In such a case, according to embodiments, it may be a task of the ‘developer’ of an experience to determine the best mapping rule for the desired experience, for example, together with (e.g., suitable) requirements to be met and constraints (e.g., to be tested against).

According to embodiments, similar to a realization (e.g., implementation) of a SF itself, a description of mapping rules (e.g., a formulation of a dynamic programming model) may be done using automated frameworks, such as Semiring or Hypergraph, for example, allowing for the expression as well as the automated testing of constraints against requirements in a formulated DP problem. According to embodiments, in the case of automated frameworks, a DP model and its testing may be (e.g., become) an (e.g., inherent) part of a service execution, for example, alongside the SF execution itself, in the form of the DP programming model being included in some form of description, such as those used for existing DP programming frameworks.

According to embodiments, testing may take place in development environments, for example, similar to emulation approaches in existing mobile development tools. In other words, according to embodiments, together with the packaging of the service functions, an ‘application package’ may be (e.g., envisioned) for a transient device, for example, to consist of the encoded DP programming model as well as the SF packages. According to embodiments, an encoded DP programming model may be (e.g., then become) an input into the DPE methods, for example, to match constraints and discovered SFs against the model and its requirements.

According to embodiments, the number of SFs resulted in this mapping may be considered as L, and all selected SF types as set Y, such that L=|Y|. According to embodiments, each yⱼ may represent an SF type, while y₀=‘control’, that is, each yⱼ may contain a super class of each SF that may be selected out of a discovered SF pool.

According to embodiments, selection of suitable SFs may depend on any of neighboring and/or previously chosen SFs. For example, according to embodiments, when selecting suitable SFs is done according to a stage-by-stage basis, selecting a SF may be done by iteratively matching the SF type (e.g., iterating through Y, matching each element) and ordering defined in Y, as the conditions such as data rates between SF may depend on the neighboring (previously chosen) SFs.

### Cost Function of a Dynamic Programming Model

According to embodiments, a user experience may be codified according to (e.g., based on, in the form of, consistent with, etc.) a dynamic programming (DP) model. According to embodiments, an explicit form of this model may be described herein, while a SW development process may use (e.g., include) software development kits, for example, as extensions to existing DP frameworks such as Semiring or Hypergraph.

According to embodiments, a cost value may be assigned for any (e.g., each, some, etc.) discovered SF xᵢ of a same type. That is, according to embodiments, in a case of selecting (e.g., the most suitable) SF per each SF type in a chain (e.g., as in Y), a cost value per each discovered SF xᵢ of same type may be assigned, for example, as there may be more than one SF of the same type available to be chosen, for example, from the discovered pool of SFs X. According to embodiments, in a case where N number of SFs have been discovered, xᵢ∈X, i=0, 1, . . . , N. According to embodiments, in a case of viewing a movie in 4 k with English subtitles, a developer of a programming model may provide a frame rate requirement of a viewing experience as a frames-per-second (fps) parameter F, which may (e.g., then) be turned into a per-frame time requirement, for example, for calculating a level of time-based requirement violation as shown in Equation (5):

$${T}_{max} = \frac{1}{F} . \qquad Equation ( 5 )$$

According to embodiments, a time for delivering one frame may be calculated as the sum of: (1) frame transfer time (e.g., using a bitrate gathered through monitoring rᵢ and frame size S bits gathered from a requested video source), and (e.g., added with) (2) frame processing time. According to embodiments, a (e.g., this) processing time may be provided as fᵢ, expressed as the number of frames the discovered SF xᵢ may process per second (e.g., during discovery, see FIG. 7). According to embodiments, a time to deliver one frame may be determined as shown in Equation (6):

$$\frac{S}{{r}_{i}} + \frac{1}{{f}_{i}} = {t}_{i} , \qquad Equation ( 6 )$$

where, rᵢ is R(xᵢ, xᵢ₋₁), the data rate between the xᵢ and the previously already selected SF xᵢ in the chain in bit/s.

According to embodiments, at each stage of decision making, rᵢ may be determined, for example, through monitoring the corresponding networks. According to embodiments, Equation (6) may be specific to the video use cases described above. According to embodiments, for example, in addition to Equation (6), other examples may optimize for any of best bandwidth (e.g., expressed in Mbit/s throughput for achieving a minimum quality of experience in terms of video quality), and lowest latency and highest bandwidth, for example, using a weighting factor for the ‘importance’ of latency against bandwidth. According to embodiments, DP programming codification frameworks, such as Semiring or Hypergraph, may be used to formulate and automatically test the DP program alongside the execution of (e.g., the selected) SF instances themselves. According to embodiments, a requirement violation (e.g., for the latency example) of the i^{th} SF (xᵢ) may be defined as shown in Equation (7):

costᵢ=tᵢ−Tₘₐₓ Equation (7).

### Requirement Violations

According to embodiments, it may be assumed that there will be a final set of selected SFs D as a subset of X (e.g., any SF dⱼ in D) that may be (e.g., is capable to be) used for constructing experiences selected from discovered X. According to embodiments, Equations (8) and (9) are:

dⱼ∈X Equation (8);

with

L=|D| Equation (9).

According to embodiments, for example, based on the cost function above, a sum of all cost values (costⱼ, i=1, 2, . . . , L) of any selected set of SFs (dⱼ∈D, i=1, 2, . . . , L) may (e.g., should) never be more than zero (e.g., 0). According to embodiments, in a case where a sum of all requirement violations is greater than zero, then a selected set of SFs may (e.g., will) not be able to achieve the frame rate requirement F provided by the developer. According to embodiments, for example, in such a case, a sum of requirement violations allowed in total for a selected set of SFs (a chain) may be considered as shown in Equation (10):

$${{\sum }_{j = 1}}^{L} {cost}_{j} . \qquad Equation ( 10 )$$

According to embodiments, any (e.g., each, some) selected SF may (e.g., should) be available to be any of used or chained at a given point in time. According to embodiments, there may be user-level controls that disable and/or enable specific service functions, for example, outside the general discovery framework itself. That is, according to embodiments, while the discovery attests this availability in terms of reachability and matching against the suitable access through the specific service function chain, there may be user-level controls that ‘disable’ or ‘enable’ specific service functions outside the general discovery framework itself. For example, an end user may decide to not expose a locally available SF instance to the overall system, for example, by disabling the specific instance from a service management user interface on the device, similar to disabling applications in app management setting UIs in existing mobile platforms. According to embodiments, an availability value aⱼ of each SF j may be set, for example, by obtaining the value from the corresponding SFs at runtime. According to embodiments, a (e.g., any) chosen SF may be used based on its availability as shown in Equation (11):

$${a}_{j} = \{ \begin{matrix}1 & if j is available \\ 0 & if j is not available\end{matrix} ∀ j = 1 , … , L . \qquad Equation ( 11 )$$

According to embodiments, a, the minimization of requirement violations through SF selection can be formulated as shown in Equation (12):

minimize Σⱼ₌₁^{L}aⱼ*costⱼ Equation (12).

According to embodiments, in a case where a minimal cost violation (e.g., as calculated by Equation (12)) does not lead to any selection of a SF chain that fulfils the cost constraint (e.g., a total costs stay below zero), the minimization will select the SF chain that violates the cost minimally, for example, therefore still selecting the best SF possible, albeit with a violation of an experience.

### Service Function Selection

According to embodiments, selection of SFs may be (e.g., is done) according to (e.g., based on) knowledge of existing SFs in the system, for example, acquired through discovery. According to embodiments, a set of discovered SFs X may be dynamically constructed, for example, and regularly updated as part of the discovery procedures discussed above. According to embodiments, for example, from a set a set of discovered SFs X, (e.g., the most suitable) SFs may be chosen as set D, such that D⊆X. According to embodiments, for each discovered SF xᵢ, information may be obtained, for example, with respect to a computing capability fᵢ in frames-per-second for said xᵢ.

According to embodiments, an iterative SF selection procedure may: (1) iterate through Y, one element at a time, selecting the suitable SFs with minimal requirement violations in X, per each SF type yⱼ in Y; (2) and populate D (e.g., which is then used for establishing a ‘transient device’ in the form of a chained set of SFs in D). According to embodiments, a set temp_d maintains a set of {xᵢ, cost_i} pairs where costᵢ may be the requirement violation of xᵢ, while min(temp_d) retunes xᵢ with minimum costᵢ in temp_d. According to embodiments, the SF selection procedure shown below may be specific to the video processing example use case and it's a specific pseudo-code execution for the identified DP program. According to embodiments, DP programming frameworks, such as Semiring or Hypergraph, may be used to determine min(temp_d), for example, which may then used for selected the representative xⱼ from the set of discovered SFs.

According to embodiments, a SF selection procedure may include any of the following procedures:

| | |
|---|---|
| 1. | Initialize temp_d = { }, D = { }, i = 0, j = 1 |
| 2. | Obtain Y and L from codification (e.g., by extracting from additional package |
| | information that contains the DP programming model in a suitable description) |
| 3. | Obtain F from user specification and calculate Tₘₐₓ according to Equation (5) |
| 4. | Obtain ‘frame size’ from the video source and assign S |
| 5. | Obtain X through discovery |
| 6. | for each yⱼ in Y, j = 0, 1, ..., L |
| 7. | temp_d : = { } |
| 8. | for each xᵢ of type yⱼ in X, i = 0, 1, ..., N |
| 9. | Obtain rᵢ based on dⱼ₋₁,and aᵢ, both through monitoring. |
| 10. | if aᵢ = 1 then |
| 11. | Obtain fᵢ from xᵢ and calculate tᵢ according to Equation (6) |
| 12. | Calculate costᵢ according to Equation (7) |
| 13. | temp_{d} := temp_{d} + {xᵢ, costᵢ} |
| 14. | end if |
| 15. | end for |
| 16. | yⱼ := min(temp_d) # minimum here is calculated over the cost element of |
| | temp_d |
| 17. | end for. |

According to embodiments, in the above shown SF selection procedure, the set of minimal individual yⱼ may also minimize the overall sum of the cost violation, for example, since the chosen delay constraint is additive. According to embodiments, following the selection of the set Y, the pinning and execution of the service function chain may (e.g., now) be realized.

According to embodiments, methods for selecting suitable compute resources from a pool of resources and the execution along the chain of selected resources may be detected, for example, by a protocol implementing the steps of said method. According to embodiments, a dynamic nature (e.g., the formation of truly transient devices instead of static function chains), may be detected by creating test cases with varying contextual conditions which in turn would lead to different execution points being selected, leading again in turn to the change in performance and observed load in the system as an indication of said transient nature of the (e.g., experience-centric) device

### CONCLUSION

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer readable medium for execution by a computer or processor. Examples of non-transitory computer-readable storage media include, but are not limited to, a read only memory (ROM), random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a UE, WTRU, terminal, base station, RNC, or any host computer.

Moreover, in the embodiments described above, processing platforms, computing systems, controllers, and other devices including the constraint server and the rendezvous point/server containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed”.

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the exemplary embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (“RAM”)) or non-volatile (e.g., Read-Only Memory (“ROM”)) mass storage system readable by the CPU. The computer readable medium may include cooperating or interconnected computer readable medium, which exist exclusively on the processing system or are distributed among multiple interconnected processing systems that may be local or remote to the processing system. It is understood that the representative embodiments are not limited to the above-mentioned memories and that other platforms and memories may support the described methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost vs. efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs), Field Programmable Gate Arrays (FPGAs) circuits, any other type of integrated circuit (IC), and/or a state machine.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

It is also to be understood that the terminology used herein is for the purpose of describing particular embodiments only, and is not intended to be limiting. As used herein, when referred to herein, the terms “user equipment” and its abbreviation “UE” may mean (i) a wireless transmit and/or receive unit (WTRU), such as described infra; (ii) any of a number of embodiments of a WTRU, such as described infra; (iii) a wireless-capable and/or wired-capable (e.g., tetherable) device configured with, inter alia, some or all structures and functionality of a WTRU, such as described infra; (iii) a wireless-capable and/or wired-capable device configured with less than all structures and functionality of a WTRU, such as described infra; or (iv) the like. Details of an example WTRU, which may be representative of any WTRU recited herein.

In certain representative embodiments, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

The herein described subject matter sometimes illustrates different components contained within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” or “group” is intended to include any number of items, including zero. Additionally, as used herein, the term “number” is intended to include any number, including zero.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

A processor in association with software may be used to implement a radio frequency transceiver for use in a wireless transmit receive unit (WTRU), user equipment (UE), terminal, base station, Mobility Management Entity (MME) or Evolved Packet Core (EPC), or any host computer. The WTRU may be used in conjunction with modules, implemented in hardware and/or software including a Software Defined Radio (SDR), and other components such as a camera, a video camera module, a videophone, a speakerphone, a vibration device, a speaker, a microphone, a television transceiver, a hands free headset, a keyboard, a Bluetooth® module, a frequency modulated (FM) radio unit, a Near Field Communication (NFC) Module, a liquid crystal display (LCD) display unit, an organic light-emitting diode (OLED) display unit, a digital music player, a media player, a video game player module, an Internet browser, and/or any Wireless Local Area Network (WLAN) or Ultra Wide Band (UWB) module.

Although the invention has been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although the invention is illustrated and described herein with reference to specific embodiments, the invention is not intended to be limited to the details shown. Rather, various modifications may be made in the details within the scope and range of equivalents of the claims and without departing from the invention.

1. A method performed by a device packaging entity (DPE) for any of dynamically packaging and dynamically assembling, a set of resources for a transient device (TD) implementing a user experience, the method comprising:
selecting a plurality of TD elements (TDEs), wherein the plurality of TDEs are selected according to requirements associated with any of the user experience and a dynamic programming model of the user experience, wherein the plurality of TDEs comprise at least two of one or more devices, one or more device parts, one or more services and one or more resources, wherein the one or more services are associated with any of the one or more devices and the one or more device parts, and wherein the one or more resources are associated with any of the one or more devices and the one or more device parts;
receiving any of configuration information and context information, associated with the plurality of TDEs, wherein any of the configuration information or the context information is associated with any of: resources, devices and services associated with the plurality of TDE;
selecting one or more TDEs from among the plurality of TDEs as one or more device components of the TD, wherein the one or more TDEs are selected according to: (1) any of one or more services and one or more resources for providing the user experience, (2) the any of configuration information and context information, and (3) a set of resources satisfying any of one or more requirements and one or more constraints associated with any of the user experience and the dynamic programming model;
transmitting an instantiation message for configuring the TD; and
transmitting and receiving information via the TD.

2. The method of claim 1, further comprising:
receiving user experience information via any of a user input, network signaling, and device signaling, wherein the user experience information indicates any of services, devices, and resources, required according to any of the user experience and the dynamic programming model; and
determining the requirements associated with the user experience according to the user experience information.

3. The method of claim 1, wherein the any of configuration information and context information is received from any of one or more service functions and one or more service function hosts.

4. The method of claim 1, wherein:
the one or more device components comprises any number of one or more service functions and one or more service function chains, and
the DPE generates the one or more service function chains.

5. The method of claim 4, wherein the instantiation message comprises information to cause instantiation of any number of the one or more service functions and the one or more service function chains.

6. The method of claim 1, wherein the instantiation message is transmitted to any number of devices.

7. The method of claim 1, wherein the any of configuration information any context information includes requirement violation information associated with the one or more device components for the TD.

8. The method of claim 7, wherein the requirement violation information is associated with or determined according to cost function associated with the user experience.

9. The method of claim 7, wherein the one or more device components are selected according to a minimization of requirement violations.

10. The method of claim 1, wherein the as one or more device components are associated with any number of one or more layers associated with the TD.

11. A wireless transmit/receive unit (WTRU) comprising circuitry, including a transmitter, a receiver and a memory, and a processor, executing a device packaging entity (DPE) for any of dynamically packaging and dynamically assembling, a set of resources for a transient device (TD) implementing a user experience, the WTRU configured to:
select a plurality of TD elements (TDEs), wherein the plurality of TDEs are selected according to requirements associated with any of the user experience or a dynamic programming model of the user experience, wherein the plurality of TDEs comprise at least two of one or more devices, one or more device parts, one or more services and one or more resources, wherein the one or more services are associated with any of the one or more devices and the one or more device parts, and wherein the one or more resources are associated with any of the one or more devices and the one or more device parts;
receive any of configuration information and context information, associated with the plurality of TDEs, wherein any of the configuration information or the context information is associated with any of: resources, devices and services associated with the plurality of TDEs;
select one or more TDEs from among the plurality of TDEs as one or more device components of the TD, wherein the one or more TDEs are selected according to: (1) any of one or more services and one or more resources for providing the user experience; (2) the any of configuration information and context information; and (3) a set of resources satisfying any of one or more requirements and one or more constraints associated with any of the user experience and the dynamic programming model;
transmit an instantiation message for configuring the TD; and
transmit and receive information via the TD.

12. The WTRU of claim 10, further configured to:
receive user experience information via any of a user input, network signaling, and device signaling, wherein the user experience information indicates any of one or more services, one or more devices, and one or more resources, required according to any of the user experience and the dynamic programming model; and
determine the requirements associated with the user experience according to the user experience information.

13. The WTRU of claim 10, wherein the any of configuration information and context information is received from any of one or more service functions and one or more service function hosts.

14. The WTRU of claim 10, wherein:
the as one or more device components comprise any number of one or more service functions and one or more service function chains, and
the DPE generates the one or more service function chains.

15. The WTRU of claim 10, wherein the instantiation message comprises information to cause instantiation of any number of the one or more service functions and the one or more service function chains.

16. The WTRU of claim 10, wherein the instantiation message is transmitted to any number of devices.

17. The WTRU of claim 10, wherein the any of configuration information any context information comprises requirement violation information associated with the one or more device components of the TD.

18. The WTRU of claim 17, wherein the requirement violation information is associated with or determined according to cost function associated with the user experience.

19. The WTRU of claim 17, wherein the one or more device components of the TD are selected according to a minimization of requirement violations.

20. The WTRU of claim 10, wherein the one or more device components of the TD are associated with any number of one or more layers associated with the TD.
